(19) United States
(12) Patent Application Publication
(10) Pub. No.: US 2025/0381608 A1
(43) Pub. Date: Dec. 18, 2025

(54) ADDITIVE REPAIR WELDING METHOD FOR HOT-WORKING MOLD

(71) Applicant: CITIC Dicastal Co., Ltd, Qinghuangdao (CN)

(72) Inventor: Taotao Liu, Qinghuangdao (CN)

(73) Assignee: CITIC Dicastal Co., Ltd, Qinghuangdao, HE (CN)

(21) Appl. No.: 19/316,962

(22) Filed: Sep. 2, 2025

(30) Foreign Application Priority Data
Sep. 30, 2024 (CN) 202411379546.2

(51) Int. Cl. B23K 9/04; B23K 9/00; B23K 9/167; B23K 9/235; B23K 37/02; B23K 37/04; B33Y 10/00; B33Y 50/00

(52) U.S. Cl. CPC B23K 9/044; B23K 9/0026; B23K 9/167; B23K 9/235; B23K 37/0229; B23K 37/0435; B33Y 10/00; B33Y 50/00

(57) ABSTRACT

An additive repair welding method for a hot-working mold includes: placing the hot-working mold in a heating holding furnace, performing heating to 420-450° C. along with the heating holding furnace, stopping performing heating, performing heat preservation for a predetermined time such that the surface temperature of an upper mold is not less than 200° C. after discharging from the furnace and before welding, while preheating a welding wire to a first predetermined temperature; gripping the hot-working mold by using a mechanical gripper to be placed on a clamping tooling, driving clamping jaws by a tooling cylinder to be automatically centered for clamping, starting a welding robot for welding until completion; opening the clamping tooling, sending the hot-working mold back to the heating holding furnace by using the mechanical gripper to be heated again to a second predetermined temperature, stopping performing heating, performing slow cooling to room temperature along with the furnace temperature.

### FIELD OF THE INVENTION

The present disclosure relates to the field of intelligent manufacturing, particularly to an additive repair welding method for a hot-working mold, and more particularly to an additive repair welding method for a hot-working mold using dual-robot automatic welding.

### BACKGROUND OF THE INVENTION

With the continuous and rapid development of the manufacturing industry, especially in the fields of new energy, new materials, intelligent manufacturing, etc., the application of molds will be more widespread, and market demands will continue to grow. This provides a broad market space and development opportunities for the mold repairing industry. More specifically, scrapped molds identified by a manufacturing department and a production workshop have a scrap ratio of only 2.66% due to structural strength problems of the molds such as bridge cracking, stress cracking, collapse deformation, core breakage, etc., while the scrapped molds have a scrap ratio of 97.34% due to non-structural strength problems, such as dimensional out-of-tolerance, the utilization rate of a mold residual value is low, and the application background of mold repair enhancement is substantial.

However, with regard to hot-working molds in high strength extrusion operating environments, due to the narrowest part to be subjected to additive repair welding (especially a lower mold working belt and a lower mold gel slot), the technical requirement is that a repair width is controlled to be only 1.5 mm, while a diameter of a welding wire for additive repair welding is 1.2 mm. The high welding requirements for narrow spaces and the material quality requirements for hot-working mold repair materials make the conventional welding process impossible to use and a standard welding gun do not work at all, the welding difficulty is extremely high, and the accuracy of repeated positioning is more demanded. In addition, the conventional welding process has defects and the temperature gradient during the welding process is difficult to control, which leads to the inability of the hot-working mold to effectively release the stress of a welding material during the additive repair welding process, and insufficient weld penetration of a welding layer, poor base material jointing, non-fusion, bubbles, inclusions, welding layer cracking, lamellar tearing, peeling, and weld seam deviation are very likely to occur on a fractured end surface of the overlay welding, which has always been a difficult problem in mold repairing, causing hot-working mold repairing to be stagnant, and even 97.34% of the molds with the non-structural strength problems can only be disposed of according to scrap, which brings huge cost losses to the production workshop.

Moreover, at present, repair welding of the hot-working mold is completely a manual operation, with low manual efficiency, single production products and a slow production cycle, and poor manual welding and unqualified products are easily caused. It is difficult to ensure product consistency, there are welding defects and safety hazards, and it is difficult to ensure that a welding layer of the repaired mold does not crack and fall off during subsequent use. In addition, the manual operation of operators in the face of the hot-working mold having a high temperature is very likely to cause a work accident such as a scald, and the operators have a resistance emotion.

### SUMMARY OF THE INVENTION

In order to solve the above problems, an object of the present disclosure is to provide an additive repair welding method for a hot-working mold, which can be used for automatic welding of the hot-working mold by a dual-robot welding device.

According to the present disclosure, provided is an additive repair welding method for a hot-working mold, including the steps of: placing the hot-working mold in a heating holding furnace, performing heating to 420-450° C. along with the heating holding furnace, stopping performing heating, and performing heat preservation for a predetermined time such that the surface temperature of an upper mold is not less than 200° C. after discharging from the furnace and before welding, while preheating a welding wire to a first predetermined temperature; gripping the hot-working mold by using a mechanical gripper to be placed on a clamping tooling, driving clamping jaws by a tooling cylinder to be automatically centered for clamping, and starting a welding robot for welding until completion; and opening the clamping tooling, sending the hot-working mold back to the heating holding furnace by using the mechanical gripper to be heated again to a second predetermined temperature, then stopping performing heating, and performing slow cooling to room temperature along with the furnace temperature, wherein the clamping tooling includes: a central gear, a first rack-and-pinion mechanism in which a rack I is engaged with the central gear, a second rack-and-pinion mechanism in which a rack II is engaged with the central gear, and clamping jaws mounted on a clamping jaw mounting plate I and a clamping jaw mounting plate II and respectively driven by the first rack-and-pinion mechanism and the second rack-and-pinion mechanism, wherein a cylinder rod end of the tooling cylinder is connected to the clamping jaw mounting plate I; wherein the welding robot is fixedly mounted on a main beam, and a left tooling mounting base plate and a right tooling mounting base plate each are equipped with a clamping tooling which is driven by a positioner to be relatively positioned relative to the main beam, wherein the positioner includes: a driven end beam connected with one end of the main beam, a drive end beam connected with the other end of the main beam, a left driven end connected with one end of the driven end beam, a left drive end connected with one end of the drive end beam, a right driven end connected with the other end of the driven end beam, and a right drive end connected with the other end of the drive end beam, wherein the left tooling mounting base plate is mounted between the left driven end and the left drive end, and the right tooling mounting base plate is mounted between the right driven end and the right drive end, wherein the left driven end includes: a left driven tooling tray for being connected with the left tooling mounting base plate, and a left driven slewing support for mounting the left driven tooling tray; the left drive end includes: a left tooling tray, and a left servo motor for rotating and driving the left tooling tray; and the right driven end and the right drive end are configured in the same manner as the left driven end and the left drive end.

Preferably, two welding robots are mounted on the main beam, each welding robot realizing a corresponding welding operation based on a respective welding program.

Preferably, the left tooling mounting base plate and the right tooling mounting base plate each are equipped with two or more sets of clamping toolings corresponding to the welding robots.

Preferably, the hot-working mold is the upper mold, including: an upper mold core for mold shaping, an upper mold diversion bridge for supporting the upper mold core, and an upper mold working belt for stabilizing a size of an extruded aluminum profile, and
when repairing the upper mold, the welding robot drives a welding gun to adopt an additive overlay welding process of vertical welding plus amplitude swing, wherein during reciprocating swing of the welding gun in a vertical welding direction, a vertical distance is adjusted at a predetermined swing frequency, amplitude reference, forward direction and dwell time of the welding gun, and backward direction and dwell time of the welding gun to perform circular welding on the upper mold core and the upper mold working belt, the welding robot is controlled to drive the welding gun to rotate, and the left drive end and/or the right drive end is controlled to synchronously rotate accordingly to adjust a rotating position to adapt to an included angle of the welding gun and an angle of hot wire filling, and always keep an overlay welding surface of the upper mold working belt upward.

Preferably, the hot-working mold is a lower mold, including: a lower mold diversion channel, a lower mold welding chamber, a lower mold working belt, and a lower mold discharge opening, deep holes are milled and reamed in the lower mold welding chamber before additive repair welding of the lower mold, a profiling plug is machined to plug and fill a position where the deep holes are milled and reamed, and the lower mold in which the deep holes are milled and reamed and plugged by the profiling plug is placed together in the heating holding furnace to be heated to 420-450° C. before additive repair welding of the lower mold, and

when repairing the lower mold, the welding robot drives a welding gun to adopt a high-weld-penetration additive overlay welding process using a dual-pulse TIG arc additive manufacturing method with stepping wire filling, wherein a metal entity is manufactured by layer-by-layer overlay welding, and during the pulse process, the lower mold welding chamber and the lower mold working belt are subjected to flat high-weld-penetration overlay welding by increasing weld penetration and arc stability at a predetermined pulse current, voltage, and frequency.

Preferably, the main beam is rotatably mounted on a base via a main beam rotary gear and a main beam ring gear which are matched to each other, wherein the main beam ring gear is mounted on the base.

Preferably, a left anti-arc device and a right anti-arc device are installed on both lateral sides of the main beam in a manner of raising or falling corresponding to the welding robot.

Preferably, the clamping tooling further includes a rack guide wheel I and a rack guide wheel II which are fixed in a manner of respectively abutting against the rack I and the rack II.

Preferably, the clamping tooling further includes: a tooling base plate, a linear guide rail I, a linear guide rail II, a guide rail slider I, and a guide rail slider II, the tooling base plate is fixed to the left tooling mounting base plate, the linear guide rail I and the linear guide rail II are mounted on a centerline of the tooling base plate in a left-right symmetry, the central gear is mounted on a central point of the tooling base plate, the guide rail slider I and the rack I are mounted under the clamping jaw mounting plate I, the guide rail slider I is matched with the linear guide rail I, the guide rail slider I and the rack II are mounted under the clamping jaw mounting plate II, the guide rail slider II is matched with the linear guide rail II, and the tooling cylinder is mounted at a front end of the tooling base plate through a cylinder connecting plate.

Preferably, the two welding robots are respectively used for welding of the upper mold and a lower mold of the hot-working mold, the upper mold includes: an upper mold core for mold shaping, an upper mold diversion bridge for supporting the upper mold core, and an upper mold working belt for stabilizing a size of an extruded aluminum profile, and the lower mold includes a lower mold diversion channel, a lower mold welding chamber, a lower mold working belt, and a lower mold discharge opening, wherein when the upper mold core extends into the lower mold welding chamber, a mating gap is formed between the upper mold core and the lower mold working belt.

The additive repair welding method according to the present disclosure has the advantages of high degree of intelligence, high precision of mold repair and less human intervention. Heat treatment before welding and heat treatment after welding are adopted to ensure the quality and mechanical properties of additive repair welding. At the same time, preheating before welding and heat treatment after welding are also necessary, which can reduce the deformation and stress during welding, and ensure the mechanical properties and stability of a welded area. A series of welding processes improved by yttrium-tungsten electrode inert gas shielded welding are adopted, and a specially-made robot welding gun with an adapted predetermined hot wire feeding structure and the length of a wire feeding tube shortened and the angle of the wire feeding tube changed is adopted, and a welding power supply control system is adopted to automatically heat and fill the welding wire. The additive repair welding method for the hot-working mold is adopted, a current does not pass through the heated welding wire itself, no spatter is generated, the welding heat input is low, the deposition efficiency is high, and the weld formation is beautiful, and at the same time, the welding quality is ensured by a control method such as removing an oxide film on the surface of a weldment.

### BRIEF DESCRIPTION OF DRAWINGS

FIG. 1 shows a cross-sectional view of an upper mold of a high-strength hot-working mold.

FIG. 2 shows a schematic perspective view of the upper mold of the high-strength hot-working mold.

FIG. 3 shows a cross-sectional view of a lower mold of the high-strength hot-working mold.

FIG. 4 shows a schematic perspective view of the lower mold of the high-strength hot-working mold.

FIG. 5 shows a cross-sectional view of the high-strength hot-working mold in a mold closing state.

FIG. 6 shows a structural diagram of a dual-robot automatic centering clamping tooling for additive repair welding of a hot-working mold.

FIG. 7 shows a layout diagram of a dual-robot automatic welding device for additive repair welding of a hot-working mold.

FIG. 8 shows an installation structure diagram of a main beam of the dual-robot automatic welding device for additive repair welding of the hot-working mold.

FIG. 9 shows a structural diagram of transmission components of the main beam of the dual-robot automatic welding device for additive repair welding of the hot-working mold.

FIG. 10 shows a structural diagram of driven parts of a positioner of the dual-robot automatic welding device for additive repair welding of the hot-working mold.

FIG. 11 shows a structural diagram of driving parts of the positioner of the dual-robot automatic welding device for additive repair welding of the hot-working mold.

FIG. 12 shows a top view of the dual-robot automatic welding device for additive repair welding of the hot-working mold.

FIG. 13 shows a schematic diagram of a repair method for the upper mold of the high-strength hot-working mold.

FIG. 14 shows an exploded view of a repair method for the lower mold of the high-strength hot-working mold.

FIG. 15 shows a schematic diagram of the repair method for the lower mold of the high-strength hot-working mold.

### DETAILED DESCRIPTION OF THE INVENTION

According to the present disclosure, a dual-robot welding device for automatic welding of a hot-working mold is provided to meet the need for additive repair welding of the hot-working mold. The automatic welding device using coordinated operations of dual robots has broad prospects and trends. In particular, by introducing artificial intelligence and a machine learning algorithm, the autonomous decision-making capability is improved, the robots can be better adapted to different welding tasks, the application level of the dual-robot automatic welding device will be further improved, two welding robots can realize data sharing and collaborative operation, the production efficiency and flexibility are improved, and there will be obvious advances in intelligence and integration.

Accordingly, the present disclosure provides an additive repair welding method for a hot-working mold, and a dual-robot welding device is used for automatic welding of the hot-working mold. This additive repair welding method for the hot-working mold can repair single-cavity hot-working molds and multi-cavity (three-cavity or four-cavity) hot-working molds. Here, only a single-cavity high-strength hot-working mold is shown for simplicity and clarity of illustration and ease of explanation. The hot-working mold is divided into two parts, namely an upper mold and a lower mold.

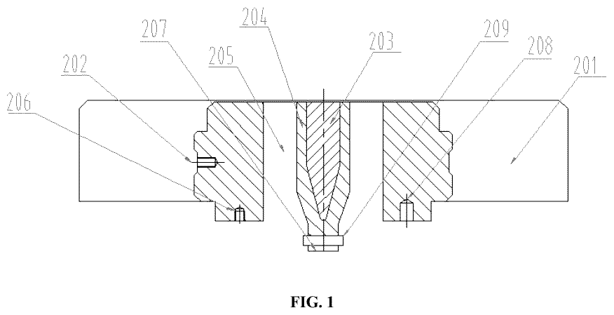

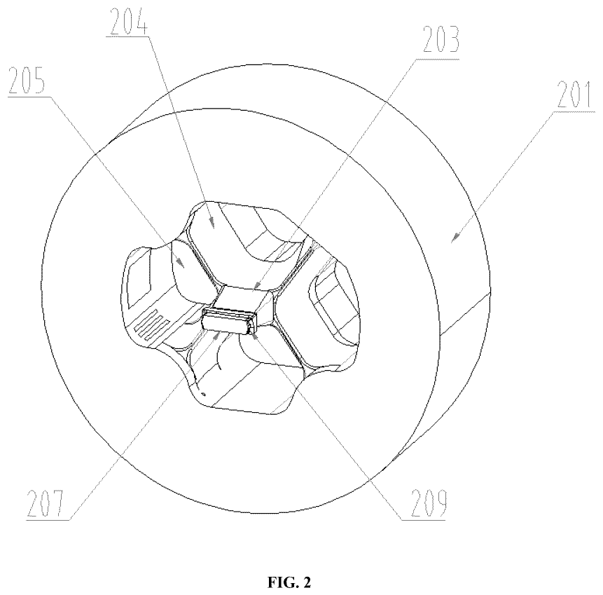

FIGS. 1 and 2 respectively show a cross-sectional view and a schematic diagram of an upper mold of a high-strength hot-working mold. An upper mold 201 mainly includes an upper mold lifting hole 202, an upper mold diversion bridge 203, an upper mold diversion cavity 204, a feeding channel 205, an upper mold mating screw hole 206, an upper mold core 207, an upper mold mating pin hole 208, and an upper mold working belt 209.

The feeding channel 205 in the upper mold 201 is responsible for material distribution and controlling the amount of feeding. The upper mold diversion bridge 203 on the upper mold 201 is an entity formed between the upper mold diversion cavities 204. The upper mold diversion cavity 204 of the single-cavity high-strength hot-working mold shown here is a 4-hole diversion cavity (FIG. 2). In the cross-sectional view (FIG. 1), only a connecting portion of the upper mold diversion cavity 204 and the upper mold diversion bridge 203 can be seen due to the hierarchical display of the cross section. The upper mold diversion bridge 203 accordingly bears support of the upper mold core 207, and the upper mold core 207 is a core component for mold shaping. If the diversion bridge 203 breaks, the upper mold core 207 is displaced and the upper mold is scrapped and cannot be repaired. The upper mold working belt 209 is a core component for sizing, and a main function of the upper mold working belt 209 is to stabilize the size of an extruded aluminum profile and ensure the surface quality of the aluminum profile. In the production process, the upper mold working belt 209 has friction between plasticized aluminum metal and the hot-working mold, thereby generating defects such as size difference of the aluminum profile, and scratches and indentations on the surface of a profile product. At this time, the mold is a faulty mold and needs to be repaired.

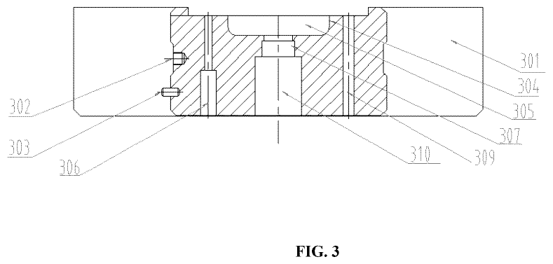

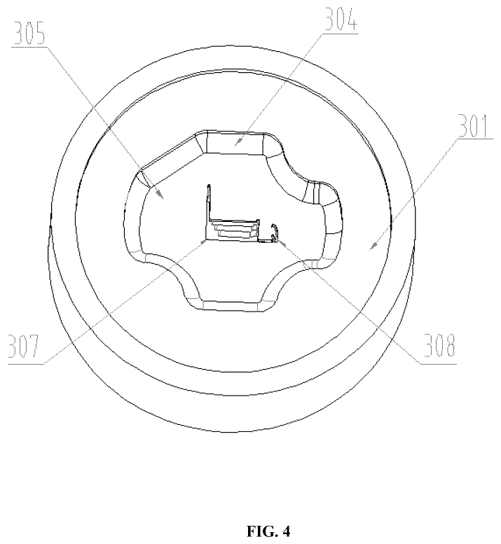

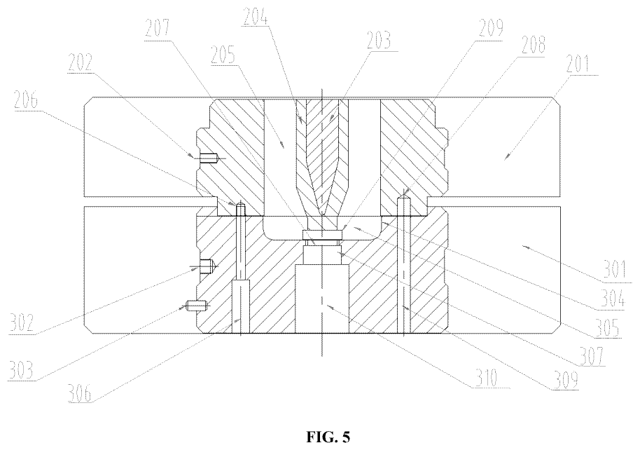

FIGS. 3 and 4 respectively show a cross-sectional view and a schematic diagram of a lower mold of the high-strength hot-working mold. A lower mold 301 mainly includes a lower mold lifting hole 302, a lower mold positioning edge pin 303, a lower mold diversion channel 304, a lower mold welding chamber 305, a lower mold mating screw hole 306, a lower mold working belt 307, a lower mold gel slot 308, a lower mold mating pin hole 309, and a lower mold discharge opening 310 (referring to FIG. 5). The lower mold welding chamber 305 is a very important cavity for fusing bars. The depth, shape and distance from a mold hole of this cavity have a significant impact on the extrusion force of the mold, product fusion quality, a product discharge rate, and profile surface quality.

FIG. 5 shows a cross-sectional view of the high-strength hot-working mold in a mold closing state. When the upper mold 201 and the lower mold 301 are closed, the upper mold 201 is embedded in the lower mold 301, a mold locking bolt passes through the lower mold mating screw hole 306 and the upper mold mating screw hole 206 to be bolted and tightly fitted in a concentric manner, and a positioning pin of the lower mold mating pin hole 309 is inserted into the upper mold mating pin hole 208 to maintain stable mold closing.

The upper mold core 207 extends into the lower mold welding chamber 305, and a mating gap between the upper mold core 207 and the lower mold working belt 307 determines the cross-sectional size of an aluminum alloy product that can be ensured when an aluminum alloy material is plasticized and extruded.

In the normal production state, the aluminum alloy material is sufficiently plasticized and enters through the feeding channel 205 of the upper mold 201, is diverted through the upper mold diversion cavity 204 and the lower mold diversion channel 304, is extruded through the upper mold working belt 209 at the bottom of the upper mold core 207, passes through the lower mold welding chamber 305 of the lower mold 301, and then passes through the lower mold working belt 307 to complete the shaping of an aluminum alloy profile, and the shaped aluminum alloy profile is discharged through the lower mold discharge opening 310 after shaping.

At this time, if the temperature of the aluminum alloy material is not precisely controlled, the material is insufficiently plasticized, excessive pressure occurs, or the outlet stress of the upper mold diversion bridge 203 on the upper mold 201 at the extrusion position is large, not only the upper mold diversion bridge 203 is split, but also the lower mold welding chamber 305 is damaged, resulting in damage to the lower mold. If impurities are included in the fused bar material, the lower mold diversion channel 304, the lower mold working belt 307, the lower mold gel slot 308 and a wear-resistant layer of the working surface of the lower mold welding chamber 305 are damaged, which directly and severely affects the stability of the profile and affects the quality of the product. However, overlay welding operations in a narrow shaping space, which require three-dimensional vertical overlay welding, and that a molten pool cannot collapse or flow have always been a blank in the repair work of additive repair welding of high-strength molds. The surface temperature of a mold to be repaired by heat treatment before welding and heat treatment after welding is not lower than 200° C., the heating temperature of a welding wire is not lower than 350° C., and there is a hazard of scalding at any time during the production cycle, completely by manual operation. Traditional standard TIG welding guns and hot wire filling systems are large in size, are cumbersome to operate, and have a large number of consideration factors, making it difficult to guarantee the overlay welding angle, hot melting depth, molten pool width and mechanical properties, appearance dimensions and the like.

In order to achieve the production requirements for batch repairing of hot-working molds and restore the problems of wear resistance and fitting accuracy of upper and lower molds, it is necessary to develop not only an additive repair welding method for a hot-working mold, but also an automatic welding device for additive repair welding of a hot-working mold. According to the present disclosure, provided is a dual-robot automatic welding device with high precision, automatic centering and automatic displacement functions for implementing a repair welding method for a hot-working mold and being used as an effective hardware support for completing the application of a repair welding process for a hot-working mold, which is also an original design intention of developing and manufacturing the dual-robot automatic welding device for additive repair welding of the hot-working mold and the additive repair welding method for the hot-working mold, which also contributes to the design concept that dual robots are directly mounted on a positioner by the dual-robot automatic welding device to achieve absolute unification of robot position coordinates and welding tooling position coordinates, automatically center clamping jaws of a clamping tooling to synchronously move in opposite directions, thus completing the automatic centering action. By using the dual-robot automatic welding device for additive repair welding of the hot-working mold and the additive repair welding method for the hot-working mold, the robot automatic welding device can be organically integrated into the additive repair welding method for the hot-working mold through digital modeling, which not only greatly avoids the risk of workers' scalding, but also makes the additive overlay welding position more precise, effectively ensuring the quality of additive repair welding of the hot-working mold, and improving the automated production efficiency.

Unlike the conventional welding technology, the additive repair welding technology described herein can numerically model discrete target entities, and then performs overlay welding in a layer-by-layer stack manner, is a disruptive repair manufacturing method, and changes the existing repair welding production method. Compared with the conventional welding technology, the additive repair welding technology can perform production and repair of more complex workpieces, with high design freedom and large manufacturing space. When producing or repairing parts having a complex shape and structure, high-precision repair and manufacturing can be realized, with high material utilization rate and low cost consumption, which has great advantages.

### <Dual-Robot Welding Device>

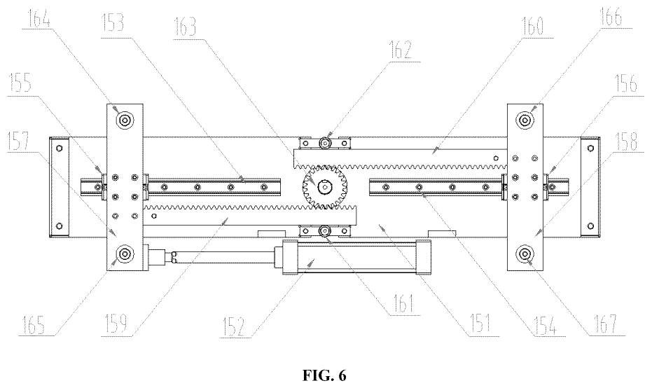

FIG. 6 shows a structural diagram of a dual-robot automatic centering clamping tooling for additive repair welding of a hot-working mold.

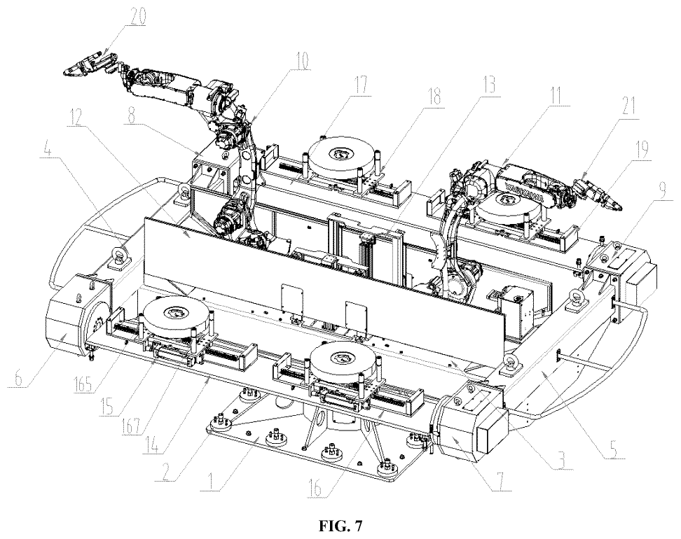

As shown in FIG. 7, the dual-robot automatic centering clamping tooling for additive repair welding of the hot-working mold is composed of a total of four sets of automatic centering clamping toolings, which are a left clamping tooling I 15, a left clamping tooling II 16, a right clamping tooling I 18, and a right clamping tooling II 19, respectively, which adopt a symmetrical layout mode and are exactly the same in housing shape and installation mode. The welding tooling for additive repair welding of the hot-working mold thus constructed can be quickly interchanged and can meet the requirements of different welding processes under different operating conditions. Description is made below by taking the left clamping tooling I 15 as an example.

The left clamping tooling I 15 mainly includes a tooling base plate 151, a tooling cylinder 152, a linear guide rail I 153, a linear guide rail II 154, a guide rail slider I 155, a guide rail slider II 156, a clamping jaw mounting plate I 157, a clamping jaw mounting plate II 158, a rack I 159, a rack II 160, a rack guide wheel I 161, a rack guide wheel II 162, a central gear 163, and an upper clamping jaw I 164 and a lower clamping jaw I 165 which are mounted on the clamping jaw mounting plate I 157, and a upper clamping jaw II 166 and a lower clamping jaw II 167 which are mounted on the clamping jaw mounting plate II 158.

The tooling base plate 151 is fixed to the left tooling mounting base plate 14 by bolts. The linear guide rail I 153 and the linear guide rail II 154 are mounted on a centerline of the tooling base plate 151 in a left-right symmetry, and the central gear 163 is mounted on a central point of the tooling base plate 151.

The guide rail slider I 155 and the rack I 159 are mounted under the clamping jaw mounting plate I 157, the guide rail slider I 155 is matched with the linear guide rail I 153, the rack I 159 is engaged with the central gear 163, and the rack guide wheel I 161 is mounted on the tooling base plate 151 in a manner of abutting against the rack I 159.

The guide rail slider I 156 and the rack II 160 are mounted under the clamping jaw mounting plate II 158, the guide rail slider II 156 is matched with the linear guide rail II 154, the rack II 160 is engaged with the central gear 163, and the rack guide wheel II 162 is mounted on the tooling base plate 151 in a manner of abutting against the rack II 160.

The tooling cylinder 152 is mounted at a front end of the tooling base plate 151 through a cylinder connecting plate. A cylinder rod end of the tooling cylinder 152 is connected to the clamping jaw mounting plate I 157.

Extension and retraction of a cylinder rod of tooling cylinder 152 drive the clamping jaw mounting plate I 157 to slide in parallel along the linear guide rail I 153 through the guide rail slider I 155, and at the same time drive the rack I 159 to rotate in a manner of being engaged with the central gear 163 under the action of the rack guide wheel I 161. The rotation of the central gear 163 drives the action of the rack II 160 engaged with the central gear 163 under the action of the rack guide wheel II 162, thereby driving the guide rail slider II 156 to slide in parallel along the linear guide rail II 154, and further driving the clamping jaw mounting plate II 158 to move horizontally synchronously. The upper clamping jaw I 164 and the lower clamping jaw I 165 which are mounted on the clamping jaw mounting plate I 157 and the upper clamping jaw II 166 and the lower clamping jaw II 167 which are mounted on the clamping jaw mounting plate II 158 are caused to move synchronously in opposite directions to complete the automatic centering action.

As shown in FIG. 7, the dual-robot automatic welding device for additive repair welding of the hot-working mold mainly includes: a base 1, adjustment bolts 2, a main beam 3, a driven end beam 4, a drive end beam 5, a left driven end 6, a left drive end 7, a right driven end 8, a right drive end 9, a robot I 10, a robot II 11, a left anti-arc device 12, a right anti-arc device 13, a left tooling mounting base plate 14, a left clamping tooling I 15, a left clamping tooling II 16, a right tooling mounting base plate 17, a right clamping tooling I 18, a right clamping tooling II 19, and a robot welding gun I 20, a robot welding gun II 21.

The base 1 is provided with an adjusting base consisting of a plurality of adjustment bolts 2, the base 1 is fixed on the ground by a plurality of chemical anchor bolts, and the base 1 is maintained in a horizontal state at all times by adjusting the plurality of adjustment bolts 2. The main beam 3 is mounted on the base 1, and one end of the main beam 3 is connected to the driven end beam 4, and the other end of the main beam 3 is connected to the drive end beam 5. The robot I 10, the robot II 11, the left anti-arc device 12, and the right anti-arc device 13 are all directly mounted on the main beam 3.

One end of the driven end beam 4 is connected to the left driven end 6 and the other end of the driven end beam 4 is connected to the right driven end 8. One end of the drive end beam 5 is connected to the left drive end 7 and the other end of the drive end beam 5 is connected to the right drive end 9. The left tooling mounting base plate 14 is mounted between the left driven end 6 and the left drive end 7, and the left clamping tooling I 15 and the left clamping tooling II 16 are mounted on the left tooling mounting base plate 14. The right tooling mounting base plate 17 is mounted between the right driven end 8 and the right drive end 9, and the right clamping tooling I 18 and the right clamping tooling II 19 are mounted on the right tooling mounting base plate 17.

According to the present disclosure, based on a standard robot TIG welding gun, by reducing the diameter of the nozzle shape of the welding gun and the hot wire feeding structure, and shortening the length of a wire feeding tube and changing the angle of the wire feeding tube, the formed specially-made robot welding gun I 20 and robot welding gun II 21 are respectively installed at an end of a sixth axis (a wrist axis) of the robot I 10 and an end of a sixth axis (a wrist axis) of the robot II 11.

The device adopts a symmetrical mirror image of a mechanical structure, and uses a center line of the main beam 3 to distinguish a left side from a right side, and the left side and the right side are exactly the same in shape, structure, layout and function. The two robots are mounted directly on the main beam 3 of the positioner, and unification of robot position coordinates and tooling position coordinates can be achieved. The accuracy of the robot position coordinates to the tooling position coordinates and the accuracy of the robot welding work will not be affected even if the position misalignment of the positioner occurs during rotation or there is a gap between teeth due to gear engagement.

When the robot I 10 or the robot II 11 performs additive repair welding on the hot-working mold, the left anti-arc device 12 and the right anti-arc device 13 correspondingly driven by a cylinder (not shown) to rise or fall, which can effectively block the welding arc, reduce and avoid the risk of the welding arc to field operators, and comply with the safety protection measures of reducing the welding hazard in the production workshop, ensuring the safety and health of operators.

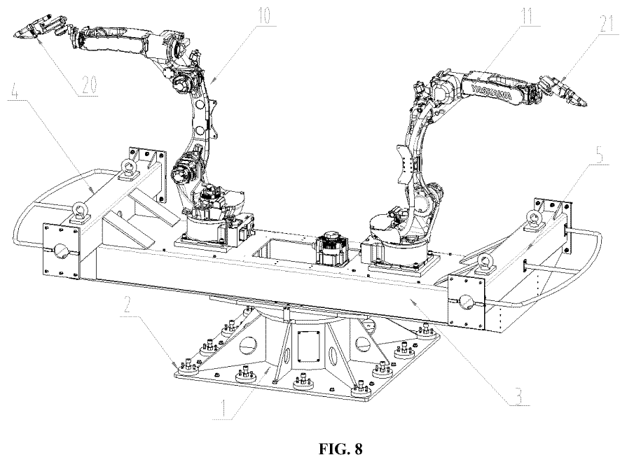

As shown in FIG. 8, the driven end beam 4 is connected to one end of the main beam 3 and is provided with a plurality of reinforcing bar plates, and the drive end beam 5 is connected to the other end of the main beam 3 and is provided with a plurality of reinforcing bar plates. An outer side of the driven end beam 4 and an outer side of the drive end beam 5 each are provided with a rotating safety rail. At the same time, for ease of hoisting and installation, the driven end beam 4 and the drive end beam 5 each are provided with two hoisting rings. Cable outlets of devices such as a control electric cabinet and a welding power supply are connected to a reserved opening of a hollow cavity of the base 1 through a cable groove laid in the ground. Cables of the two robots, and cables of the two sets of welding guns, wire feeding cables and the like are installed on robot bodies through the cable groove and the reserved opening, communicating with the main beam 3, of the base 1.

The dual-robot automatic welding device for additive repair welding of the hot-working mold is designed with an anti-arc plate and a safety protection room with smoke-proof and dust-proof functions, and is equipped with supporting facilities such as welding dust-removal pipeline, welding explosion-proof lighting, welding shielding gas, a welding wire heating system, and a water-cooling circulation system. When a safety door of the safety protection room is opened, the robots stop working. The safety door of the safety protection room is equipped with a mortise lock, and the mortise lock is equipped with a safety indicator light prompt function when opened and closed. A two-way three-dimensional safety light curtain is disposed in the manual operation position, effectively protecting the safety of the operator. The device is also provided with a plurality of emergency stop buttons mounted on a robot control box panel and a safety door control panel to facilitate operation by the operator in the event of an abnormality. When the operator presses the emergency stop button, it is ensured that the welding robots do not start automatically.

As described in detail later, a control mode of the dual robots cooperating with the positioner and four sets of toolings on both sides of the positioner is adopted, and a plurality of rotary axes are used as extension axes of the robots, and the coordinated and integrated control can ensure the optimization of the production cycle to the greatest extent. In this way, the leading technical advantages of additive repair welding of different hot-working molds can be achieved, different toolings can be configured, the production flexibility can be improved, the production cycle can be improved, the welding quality can be improved, and the product yield can be increased.

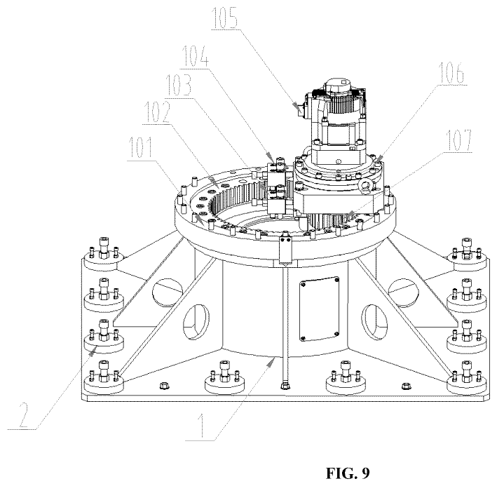

FIG. 9 shows a structural diagram of transmission components of the main beam of the positioner of this device, which mainly includes: a main beam slewing support 101, a main beam ring gear 102, a jacking support I 103, a jacking support II 104, a main beam servo motor 105, a main beam planetary reducer 106, and a main beam rotary gear 107.

The main beam ring gear 102 is fixed to the base 1 by bolts, and an upper edge of the base 1 is provided with the main beam slewing support 101. The main beam 3 (FIG. 8) has a hollow frame structure, and the jacking support I 103, the jacking support II 104 and the main beam planetary reducer 106 are mounted on a bottom plate of the main beam 3 (FIG. 8) by bolts, and the bottom plate of the main beam 3 is provided with a through hole for allowing the main beam rotary gear 107 to pass through. The bottom plate of the main beam 3 (FIG. 8) is connected to the main beam slewing support 101 by bolts. The main beam slewing support 101 is a support system capable of realizing balance and stability of rotational movement of the main beam 3, and has significant features of high load capacity and large load carrying stiffness.

The main beam servo motor 105 is connected to the main beam planetary reducer 106, an output shaft of the main beam planetary reducer 106 is connected to the main beam rotary gear 107 by a key, and the main beam rotary gear 107 cooperates with the main beam ring gear 102. The number of teeth of the main beam ring gear 102 is a multiple of that of the main beam rotary gear 107. A modulus of the main beam rotary gear 107 is calculated to control a pressure angle of the main beam rotary gear 107 at 20 degrees.

The jacking support I 103 and the jacking support II 104 jack the main beam servo motor 105 through adjustment bolts, and the main beam servo motor 105 rotates to drive the main beam rotary gear 107 to perform internal gear transmission along the main beam ring gear 102, and the main beam 3 is rotated by the main beam slewing support 101 while improving the transmission efficiency and reducing the transmission noise.

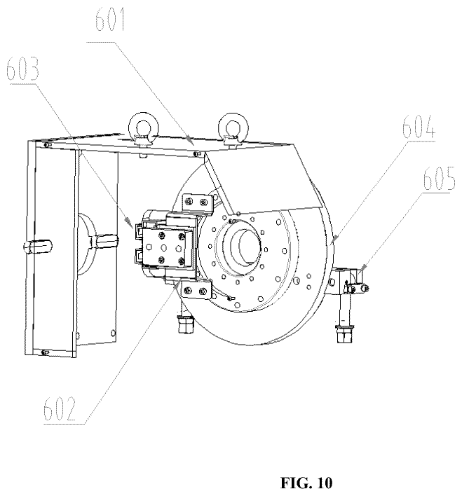

FIG. 10 shows a structural diagram of driven parts of the positioner of this device, and a symmetrical mirror image and symmetrical layout of a mechanical structure are adopted. As driven ends of the positioner, the left driven end 6 and the right driven end 8 are completely the same in terms of housing shape, internal configuration and mounting manner. Description is made below by taking the left driven end 6 as an example.

The left driven end 6 mainly includes a left driven mounting frame 601, a left carbon brush holder 602, a left carbon brush 603, a left driven slewing support 604, and a left driven tooling tray 605.

The left driven tooling tray 605 is mounted on the left driven slewing support 604 to facilitate connection of the left tooling mounting base plate 14, and the left driven slewing support 604 is mounted on the left driven mounting frame 601. The left driven mounting frame 601 is connected to one end of the driven end beam 4 by high-strength bolts, and two hoisting rings are mounted on the left driven mounting frame 601 for ease of hoisting and mounting.

The left carbon brush holder 602 is installed inside the left driven mounting frame 601, and the left carbon brush holder 602 is provided with a carbon brush leaf spring and the left carbon brush 603, and the left carbon brush 603 is always in contact with the inside of the left driven slewing support 604 under the pressure of the carbon brush leaf spring, and a conductive copper wire of the left carbon brush 603 is connected to a common terminal of a power source. During the production process, a welding current can be made to flow into the conductive copper wire of the left carbon brush 603, avoiding equipment failure and servo motor failure caused by the current, and ensuring the safety of the operator.

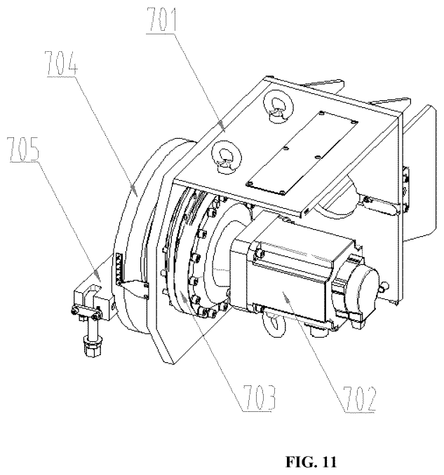

FIG. 11 shows a structural diagram of driving parts of the positioner of this device, and a symmetrical mirror image and symmetrical layout of a mechanical structure are adopted. As drive ends of the positioner, the left drive end 7 and the right drive end 9 are completely the same in terms of housing shape, internal configuration and mounting manner. The driving part structure is illustrated by taking the left drive end 7 as an example.

The left drive end 7 mainly includes a left-transmitting mounting frame 701, a left servo motor 702, a left servo reducer 703, a left-transmitting slewing support 704, and a left-transmitting tooling tray 705.

The left-transmitting mounting frame 701 is connected to one end of the drive end beam 5 by high-strength bolts, and two hoisting rings are mounted on the left-transmitting mounting frame 701 for ease of hoisting and mounting.

The left-transmitting slewing support 704 is mounted on the left-transmitting mounting frame 701. The left servo motor 702 is mounted on the left servo reducer 703. An output shaft of the left servo reducer 703 is connected to the left-transmitting slewing support 704 by a cylindrical key, and the left-transmitting tooling tray 705 is mounted on the left-transmitting slewing support 704 to facilitate connection of the left tooling mounting base plate 14. Rotation of the left servo motor 702 drives the left-transmitting tooling tray 705.

The left servo motor 702 is coordinately controlled by a program system, which can realize the servo cooperative work, greatly adapt to the demand of tooling angle turning in the production process, and make the additive repair welding operation of hot-working molds easier and simpler, more practical, and suitable for workshop production and promotion.

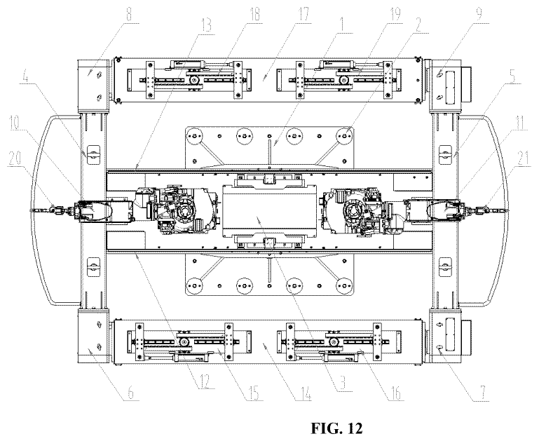

FIG. 12 shows a top view of the dual-robot automatic welding device for additive repair welding of the hot-working mold.

As described above, this dual-robot automatic welding device for additive repair welding of the hot-working mold consists of three parts, namely dual robots and a positioner and an automatic clamping tooling.

The robots mainly include: a robot I 10, a robot II 11, and a robot welding gun I 20 and a robot welding gun II 21 which are arranged accordingly.

The positioner mainly includes: a base 1, adjustment bolts 2, a main beam 3, a driven end beam 4, a drive end beam 5, a left driven end 6, a left drive end 7, a right driven end 8, a right drive end 9, a left anti-arc device 12, a right anti-arc device 13, and a left tooling mounting base plate 14.

The automatic clamping tooling mainly includes: a left clamping tooling I 15, a left clamping tooling II 16, a right tooling mounting base plate 17, a right clamping tooling I 18, a right clamping tooling II 19.

### <Additive Repair Welding Method for Hot-Working Mold>

A program of the dual-robot automatic welding device for additive repair welding of the hot-working mold can simultaneously implement different operation methods of additive repair welding on the upper mold 201 and the lower mold 301 at different repair positions, greatly improving the flexibility of additive repair welding of the dual-robot automatic welding device. The application of this program of the robot automatic welding device, particularly in the field of mold repairing, exhibits its high degree of automation and intelligence by combining the robot technology with the additive manufacturing technology. In addition, the application of these technologies not only promotes the progress of materials science, but also provides a broader technical support for the development of the program of the robot automatic welding device, making the operation of additive repair welding of molds more precise and efficient.

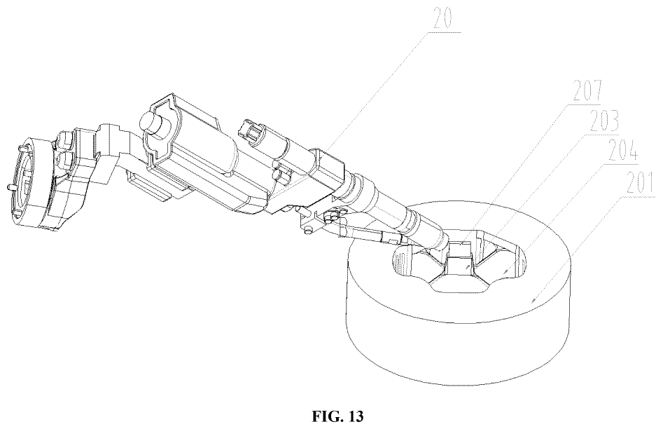

FIG. 13 shows a schematic diagram of a repair method for the upper mold of the high-strength hot-working mold.

First, when additive manufacturing, repairing, welding of high-strength hot-working molds, due to their high demands on mechanical properties, appropriate heat treatment and post-treatment processes must be adopted to ensure quality and mechanical properties of weld seams. At the same time, preheating and post-heat treatment are also necessary, which can reduce deformation and stress during the welding process, and ensure mechanical properties and stability of a welded area.

Specifically, the upper mold 201 is placed in a heating holding furnace before the additive repair welding of the upper mold 201, heating is performed to 420-450° C. along with the heating holding furnace, the heating is then stopped, and heat preservation is performed for a predetermined time such as 1 hour, wherein the surface temperature of the upper mold 201 is not less than 200° C. after discharging from the furnace and before welding. Meanwhile, a 40CrNi2Mo dedicated welding wire is preheated before welding in order to avoid peeling and cracking during the welding process. The welding wire is heated by the dual-robot automatic welding device for additive repair welding of the hot-working mold. The first predetermined temperature of preheating the welding wire is controlled to be about 350° C. before the welding wire can be used for additive repair welding of the hot-working mold.

In order to facilitate the repair of the narrow space of the hot-working mold, the use of standard TIG welding guns does not have a sufficient operating space, and the specially-made robot welding gun I 20 and robot welding gun II 21 with a predetermined wire feeding structure and the length of a wire feeding tube correspondingly shortened and the angle of the wire feeding tube changed are adopted. According to the system program control, when repairing the upper mold 201, the welding robot drives the specially-made welding guns to adopt an additive overlay welding process of vertical welding plus amplitude swing, wherein during reciprocating swing of the welding gun in a vertical welding direction, a vertical distance is adjusted at a predetermined swing frequency, amplitude reference, forward direction and dwell time of the welding gun, and backward direction and dwell time of the welding gun to mainly perform circular welding on the upper mold core 207 and the upper mold working belt 209 of the upper mold 201.

In the repair process of additive repair welding of the upper mold 201, the upper mold core 207 and the upper mold working belt 209 are mainly repaired by additive repair welding, and the length and position of the designed upper mold working belt 209 are restored, which can ensure dimensional stability of the product during extrusion and avoid dimensional fluctuations caused by changes in a metal flow rate. During the repair welding process, the dual-robot system controls the robot welding guns to rotate and a transmission part of the main beam of the positioner, the main beam servo motor 105 to rotate and servo motors at the left drive end 7 and the right drive end 9 to synchronously rotate to adjust the rotation position from time to time. In order to adapt to the optimal TIG welding gun angle and hot wire filling angle, an overlay welding surface of the upper mold working belt 209 is always kept upward to avoid flowing in a molten pool, and the welding wire filling length is calculated in real time, with reference to the wall thickness difference of profiles, the distance of the upper mold working belt 209 from the center of the upper mold core 207 and a portion of the upper mold diversion cavity 204 covered by the upper mold diversion bridge 203 and the like, the length and position of the upper mold working belt 209 are ensured to be reasonable, thereby ensuring the size of the extruded aluminum profile and ensuring the surface quality of the aluminum profile and the service life of the mold after repair.

In the welding process of ensuring additive repair welding, the stress release is effectively controlled. Under the condition that there is no welding layer connection, no bubbles, no inclusions, no cracking, no peeling, etc. on a fractured end surface of overlay welding, a minimum outer profile of the repaired size after additive repair welding must meet an upper limit size required by a drawing of the upper mold 201, the critical numerical dimensions such as the size of the upper mold core 207 and the size of the relative position of the upper mold diversion bridge 203 must be ensured, and a workable amount must be reserved for subsequent processing. After additive repair welding, the upper mold working belt 209 is finished by wire cutting, a four-axis machine tool, and other devices. And sufficient machining allowance is reserved for subsequent machining and shaping processes.

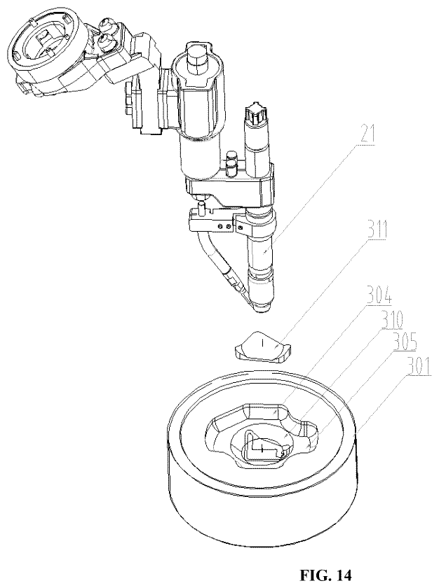

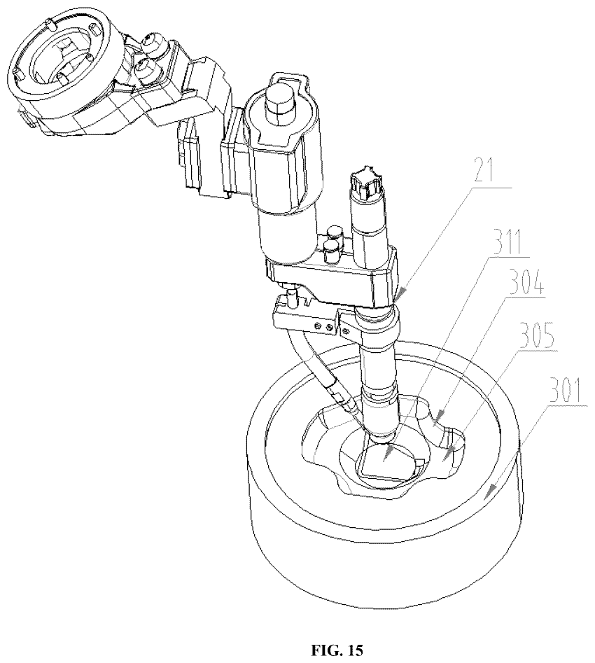

FIGS. 14 and 15 show an exploded view and a schematic diagram of a repair method for the lower mold of the high-strength hot-working mold.

Since the lower mold 301 has a narrower repair position space, before additive repair welding of the lower mold 301, a numerical control machining center is used for pre-processing, and deep holes are milled and reamed in the lower mold welding chamber 305. A welding chamber shown by 310 in FIG. 14 is milled downward to a depth of 15 mm, and a groove angle is controlled at 55°, and a profiling plug 311 is machined to plug and fill a position where the deep holes are milled and reamed. Before additive repair welding of the lower mold 301, the lower mold 301 in which the deep holes are milled and reamed and plugged by the profiling plug is placed in the heating holding furnace, heating is performed to 420-450° C. along with the heating holding furnace, the heating is then stopped and the temperature is maintained for 1 hour, wherein the surface temperature of the lower mold 301 is not less than 200° C. after discharging from the furnace and before welding. Meanwhile, a 40CrNi2Mo dedicated welding wire is preheated before welding in order to avoid peeling and cracking during the welding process. The welding wire is heated by the dual-robot automatic welding device for additive repair welding of the hot-working mold. The preheating temperature of the welding wire is controlled to be about 350° C. before the welding wire can be used for additive repair welding of the hot-working mold.

In order to facilitate the repair of the narrow space of the hot-working mold, the specially-made robot welding gun I 20 and robot welding gun II 21 with a predetermined wire feeding structure and the length of a wire feeding tube correspondingly shortened and the angle of the wire feeding tube changed are adopted. According to the system program control, when repairing the lower mold 301, the robot drives the specially-made welding guns to adopt a high-weld-penetration dual-pulse additive overlay welding process using a dual-pulse TIG arc additive manufacturing method with stepping wire filling, wherein a metal entity is manufactured by layer-by-layer overlay welding, and during the pulse process, the pulse current, voltage, and frequency are determined, weld penetration and arc stability are increased, the lower mold welding chamber 305 and the lower mold working belt 307 of the lower mold 301 are mainly subjected to flat high-weld-penetration overlay welding, which provides unparalleled advantages over other current technologies in terms of quality, efficiency, and cost.

In the repair process of additive repair welding of the lower mold 301, the lower mold diversion channel 304, the lower mold welding chamber 305, and the lower mold working belt 307 are mainly repaired by additive repair welding, and the dual-robot system likewise controls the robot welding guns to rotate and a transmission part of the main beam of the positioner, the main beam servo motor 105 to rotate and servo motors of the left drive end 7 and the right drive end 9 to synchronously rotate, and adjustments are performed from time to time. In order to adapt to the optimal TIG welding gun angle, hot wire filling angle and welding gun angle, an overlay welding surface of the lower mold welding chamber 305 is always kept upward to avoid flowing in a molten pool, a working surface of the lower mold welding chamber 305 is subjected to overlay welding, and the working surface of the welding chamber 305 is repaired. Overlay welding is performed on the position of the lower mold working belt 307, after repair welding is completed, in order to reinforce the strength of the lower mold working belt 307, the length and position of the designed lower mold welding chamber 305 and the lower mold working belt 307 are restored, and in the welding process of ensuring additive repair welding, the stress release is also effectively controlled. Under the condition that there is no welding layer connection, no bubbles, no inclusions, no cracking, no peeling, etc. on a fractured end surface of overlay welding, a minimum outer profile of the repaired size after additive repair welding must meet an upper limit size required by a drawing of the lower mold 301, the critical numerical dimensions such as the mold core size and the size of the relative position must be ensured, and a workable amount must be reserved for subsequent processing. After additive repair welding, the lower mold working belt 307 is finished by wire cutting, a four-axis machine tool, and other devices. And sufficient machining allowance is reserved for subsequent machining and shaping processes.

In the additive repair welding method for the hot-working mold, after the repairing is completed by additive repair welding, the upper mold 201 and the lower mold 301 after the additive repair welding are sent back again to the heating holding furnace and heated again to a second predetermined temperature, for example, 400° C., and then the heating is stopped and slow cooling is performed to room temperature along with the furnace temperature to prevent cracking of an additive repair welding material caused by air cooling. It is ensured that an overlay welding material and a base material have good metallurgical bonding, avoiding reducing the properties of the base material and the welding material.

The additive repair welding method for the hot-working mold also ensures that the repaired mold does not decay in hardness at high temperatures and has high creep resistance. In fact, the wear life is not only related to hardness, but also porosity and density. Wear-resistant materials working under higher temperature conditions can be used for overlay welding coverage to improve the high-temperature strength and high-temperature softening resistance of the mold, and improve the service life of the mold. The surface of the hot-working mold is subjected to repairing, repair welding or overlay welding by additive repair welding method for the hot-working mold, so that the hot-working mold has excellent high-temperature tensile strength and high-temperature wear resistance. As for the surface indexes such as cracks and hardness, mold nitriding treatment is used subsequently. The hardness after nitriding must meet the requirement of higher than 57HRC (the thickness of the nitrided layer is 90-130 μm).

### Embodiment

According to one embodiment of the present disclosure, provided are a dual-robot automatic welding device for additive repair welding of a hot-working mold and an additive repair welding method for a hot-working mold. A specific operation process is as follows:

First, through a touch screen window on an electrical cabinet, an initialized robot position signal and a protection function detection signal are set, a model of a welding material, a job number of a welding process selected for an upper mold of the hot-working mold, and a job number (Job) of a welding process selected for a lower mold of the hot-working mold, a real-time flow rate of cooling water is set, and parameters such as a real-time pressure of shielding gas are set. It is ensured that all four sets of clamping toolings are in an open state to facilitate charging.

Before welding, an upper mold 201 and a lower mold 301 are placed in a heating holding furnace, heating is performed to 420-450° C. along with the furnace, and the temperature is maintained for 1 hour, wherein the mold temperature during welding after discharging from the furnace is not less than 200° C. At this time, an operator uses a matching mechanical gripper to grip the upper mold 201 and the lower mold 301 to be placed on a left clamping tooling I 15, a left clamping tooling II 16, a right clamping tooling I 18, and a right clamping tooling II 19 of the dual-robot automatic welding device.

By a touch screen of the dual-robot automatic welding device, whether the upper mold 201 or the lower mold 301 on the left clamping tooling I 15, the left clamping tooling II 16, the right clamping tooling I 18, and the right clamping tooling II 19 requires additive repair welding is set, a program of the robot automatic welding device controls actions of the left clamping tooling I 15, the left clamping tooling II 16, the right clamping tooling I 18, the right clamping tooling II 19, and a tooling cylinder to drive clamping jaws to be automatically centered for automatic clamping.

The toolings automatically clamp a workpiece, the operator presses a start button of the device, a welding power supply is started, the protective function is started, a welding robot is started, a cooling water circulation system is started, and shielding gas pressure monitoring is started. A left anti-arc device 12 and a right anti-arc device 13 rise to block a welding arc.

At this time, the program of the device controls a left drive end 7 and a right drive end 9 of a positioner to rotate, driving a left tooling mounting base plate 14 and a right tooling mounting base plate 17 to rotate. And a relative optimal welding angle between a workpiece to be welded clamped by the left clamping tooling I 15, the left clamping tooling II 16, the right clamping tooling I 18, the right clamping tooling II 19, and the robot welding gun is always maintained. In response to different welding positions and different welding technical requirements of the upper mold 201 and the lower mold 301 of the workpiece to be welded, by cooperating with a dual-welding power source, the dual robots select welding programs with different job numbers, and simultaneously implement a plurality of welding operations on the workpiece to be welded, and the two robots have a clear division of labor and cooperate with each other, and can cooperatively perform welding and operation, avoiding collision and interference, so that the welding operation can be performed efficiently, and the production efficiency is improved, and the product consistency is improved.

After welding is complete, the welding robots return to the initial position. The positioner drives the tooling to rotate to a safe position. The four sets of clamping toolings are all in the open state, facilitating charging and a new round of welding operations.

The upper mold 201 and the lower mold 301 after repair welding are sent back to the heating holding furnace again to be heated to 400° C., and then the heating is stopped, and slow cooling is performed to room temperature along with the furnace temperature to prevent cracking of the welding material due to air cooling.

### <Deformation>

There are alternative solutions for the proposed technical solution, for example, other forms of robots are used to replace the robot I 10 and the robot II 11, other forms of driven components are used to replace the driven end beam 4, the left driven end 6, the right driven end 8, other forms of driving components are used to replace the drive end beam 5, the left drive end 7, and the right drive end 9, and other forms of clamping toolings are used to replace the left clamping tooling I 15, the left clamping tooling II 16, the right clamping tooling I 18, and the right clamping tooling II 19, etc., all of which are within the scope of protection of the present disclosure.

According to the present disclosure, the repair welding method for hot-working mold made of a high-strength material not only integrates the high-temperature tempering temperature control process and the machining precision control process of heat-resistant molds in the early, middle, and late stages, but also effectively avoids phenomena such as insufficient weld penetration of a welding layer, poor base material jointing, overheating embrittlement, etc., without non-fusion, bubbles, and inclusions.

The robot welding device developed for the repair welding method for the hot-working mold has stronger autonomous learning and adaptability, and is more intelligent and internet-enabled. By techniques such as robotic teaching and deep programming, the dual-robot automatic welding device for additive repair welding of the hot-working mold adopts a robot pulse wire feeding mode through a unified intelligent welding process, wherein the wire feeding amount is determined according to the size of the position requiring additive repair welding. Since the dual-robot automatic welding device for additive repair welding of the hot-working mold uses a heated welding wire, the wire feeding amount is inversely proportional to the welding stress, and the current is directly proportional to the welding stress. The wire feeding speed and welding current are effectively controlled, which effectively avoids the fracture and peeling of the welding layer of the hot-working mold during the welding process. The dual-robot automatic welding and the repair welding method for the hot-working mold can better understand and adapt to the complex welding environment, can realize remote monitoring and remote control, improve welding quality, improve production efficiency, and improve adaptability and flexibility of production.

To achieve automatic welding by the additive repair welding method for the hot-working mold, the technical levels in terms of intelligence, technical improvement and technical innovation of the robot welding device are also constantly increasing, and the main research contents include extraction of a failed part of the mold, feasibility analysis on the whole mold repair system, and robot path planning, construction of a kinematic model of a robot, and development of required software. By a method of directly mounting dual robots on the positioner, absolute unification of robot position coordinates and welding tooling position coordinates is achieved. The dual-robot automatic welding device achieves unification of an axial spacing of a positioning tooling carrying tray and the size of the tooling mounting base plates on both sides of the device. According to the dual-robot automatic welding device for additive repair welding of the hot-working mold, a positioning rotary axis and the tooling rotary axis are used as extension axes of the robots for coordinated and integrated control, the two robots cooperate with the positioner and the four sets of toolings on both sides of the positioner, the installation dimensions of welding toolings are standardized, the operation is simple, and the positioning is accurate. Even if the position misalignment of the positioner occurs during rotation or there is a gap between teeth due to gear engagement, the accuracy of the welding work when the robot performs additive repair welding on the hot-working mold will not be affected.

Meanwhile, with the improvement of environmental awareness, the additive repair welding method for the hot-working mold and the dual-robot automatic welding device for additive repair welding of the hot-working mold pay more attention to environmental protection and energy conservation, and adopt a low-smoke-dust low-energy-consumption welding device and materials, achieving a green and environmental friendly production manner. Pollution to the environment is reduced and waste of resources is reduced. The automated and intelligent process of intelligent manufacturing industrial production is further promoted.

1. An additive repair welding method for a hot-working mold, comprising the steps of:
placing the hot-working mold in a heating holding furnace, performing heating to 420-450° C. along with the heating holding furnace, stopping performing heating, and performing heat preservation for a predetermined time such that the surface temperature of an upper mold (201) is not less than 200° C. after discharging from the furnace and before welding, while preheating a welding wire to a first predetermined temperature;
gripping the hot-working mold by using a mechanical gripper to be placed on a clamping tooling, driving clamping jaws by a tooling cylinder (152) to be automatically centered for clamping, and starting a welding robot for welding until completion; and
opening the clamping tooling, sending the hot-working mold back to the heating holding furnace by using the mechanical gripper to be heated again to a second predetermined temperature, then stopping performing heating, and performing slow cooling to room temperature along with the furnace temperature,
wherein the clamping tooling comprises: a central gear (163), a first rack-and-pinion mechanism in which a rack I (159) is engaged with the central gear (163), a second rack-and-pinion mechanism in which a rack II (160) is engaged with the central gear (163), and clamping jaws mounted on a clamping jaw mounting plate I (157) and a clamping jaw mounting plate II (158) and respectively driven by the first rack-and-pinion mechanism and the second rack-and-pinion mechanism, wherein a cylinder rod end of the tooling cylinder (152) is connected to the clamping jaw mounting plate I (157);
wherein the welding robot is fixedly mounted on a main beam (3), and a left tooling mounting base plate (14) and a right tooling mounting base plate (17) each are equipped with a clamping tooling which is driven by a positioner to be relatively positioned relative to the main beam (3), wherein the positioner comprises: a driven end beam (4) connected with one end of the main beam (3), a drive end beam (5) connected with the other end of the main beam (3), a left driven end (6) connected with one end of the driven end beam (4), a left drive end (7) connected with one end of the drive end beam (5), a right driven end (8) connected with the other end of the driven end beam (4), and a right drive end (9) connected with the other end of the drive end beam (5), wherein the left tooling mounting base plate (14) is mounted between the left driven end (6) and the left drive end (7), and the right tooling mounting base plate (17) is mounted between the right driven end (8) and the right drive end (9), wherein the left driven end (6) comprises: a left driven tooling tray (605) for being connected with the left tooling mounting base plate (14), and a left driven slewing support (604) for mounting the left driven tooling tray (605); the left drive end (7) comprises: a left-transmitting tooling tray (705), and a left servo motor (702) for rotating and driving the left-transmitting tooling tray (705); and the right driven end (8) and the right drive end (9) are configured in the same manner as the left driven end (6) and the left drive end (7).

2. The additive repair welding method for a hot-working mold according to claim 1, wherein two welding robots are mounted on the main beam (3), each welding robot realizing a corresponding welding operation based on a respective welding program.

3. The additive repair welding method for a hot-working mold according to claim 2, wherein the left tooling mounting base plate (14) and the right tooling mounting base plate (17) each are equipped with two or more sets of clamping toolings corresponding to the welding robots.

4. The additive repair welding method for a hot-working mold according to claim 1, wherein the hot-working mold is the upper mold (201), comprising: an upper mold core (207) for mold shaping, an upper mold diversion bridge (203) for supporting the upper mold core (207), and an upper mold working belt (209) for stabilizing a size of an extruded aluminum profile, and
when repairing the upper mold (201), the welding robot drives a welding gun to adopt an additive overlay welding process of vertical welding plus amplitude swing, wherein during reciprocating swing of the welding gun in a vertical welding direction, a vertical distance is adjusted at a predetermined swing frequency, amplitude reference, forward direction and dwell time of the welding gun, and backward direction and dwell time of the welding gun to perform circular welding on the upper mold core (207) and the upper mold working belt (209), the welding robot is controlled to drive the welding gun to rotate, and the left drive end (7) and/or the right drive end (9) is controlled to synchronously rotate accordingly to adjust a rotating position to adapt to an included angle of the welding gun and an angle of hot wire filling, and always keep an overlay welding surface of the upper mold working belt (209) upward.

5. The additive repair welding method for a hot-working mold according to claim 1, wherein the hot-working mold is a lower mold (301), comprising: a lower mold diversion channel (304), a lower mold welding chamber (305), a lower mold working belt (307), and a lower mold discharge opening (310), deep holes are milled and reamed in the lower mold welding chamber (305) before additive repair welding of the lower mold (301), a profiling plug (311) is machined to plug and fill a position where the deep holes are milled and reamed, and the lower mold (301) in which the deep holes are milled and reamed and plugged by the profiling plug (311) is placed together in the heating holding furnace to be heated to 420-450° C. before additive repair welding of the lower mold (301), and
when repairing the lower mold (301), the welding robot drives a welding gun to adopt a high-weld-penetration additive overlay welding process using a dual-pulse TIG arc additive manufacturing method with stepping wire filling, wherein a metal entity is manufactured by layer-by-layer overlay welding, and during the pulse process, the lower mold welding chamber (305) and the lower mold working belt (307) are subjected to flat high-weld-penetration overlay welding by increasing weld penetration and arc stability at a predetermined pulse current, voltage, and frequency.

6. The additive repair welding method for a hot-working mold according to claim 1, wherein the main beam (3) is rotatably mounted on a base (1) via a main beam rotary gear (107) and a main beam ring gear (102) which are matched to each other, wherein the main beam ring gear (102) is mounted on the base (1).

7. The additive repair welding method for a hot-working mold according to claim 1, wherein a left anti-arc device (12) and a right anti-arc device (13) are installed on both lateral sides of the main beam (3) in a manner of raising or falling corresponding to the welding robot.

8. The additive repair welding method for a hot-working mold according to claim 1, wherein the clamping tooling further comprises a rack guide wheel I (161) and a rack guide wheel II (162) which are fixed in a manner of respectively abutting against the rack I (159) and the rack II (160).

9. The additive repair welding method for a hot-working mold according to claim 1, wherein the clamping tooling further comprises: a tooling base plate (151), a linear guide rail I (153), a linear guide rail II (154), a guide rail slider I (155), and a guide rail slider II (156), wherein the tooling base plate (151) is fixed to the left tooling mounting base plate (14), the linear guide rail I (153) and the linear guide rail II (154) are mounted on a centerline of the tooling base plate (151) in a left-right symmetry, the central gear (163) is mounted on a central point of the tooling base plate (151), the guide rail slider I (155) and the rack I (159) are mounted under the clamping jaw mounting plate I (157), the guide rail slider I (155) is matched with the linear guide rail I (153), the guide rail slider I (156) and the rack II (160) are mounted under the clamping jaw mounting plate II (158), the guide rail slider II (156) is matched with the linear guide rail II (154), and the tooling cylinder (152) is mounted at a front end of the tooling base plate (151) through a cylinder connecting plate.

10. The additive repair welding method for a hot-working mold according to claim 2, wherein the two welding robots are respectively used for welding of the upper mold (201) and a lower mold (301) of the hot-working mold, wherein the upper mold (201) comprises: an upper mold core (207) for mold shaping, an upper mold diversion bridge (203) for supporting the upper mold core (207), and an upper mold working belt (209) for stabilizing a size of an extruded aluminum profile, and the lower mold (301) comprises a lower mold diversion channel (304), a lower mold welding chamber (305), a lower mold working belt (307), and a lower mold discharge opening (310), wherein when the upper mold core (207) extends into the lower mold welding chamber (305), a mating gap is formed between the upper mold core (207) and the lower mold working belt (307).
